(19) United States
(12) Patent Application Publication
(10) Pub. No.: US 2013/0340618 A1
(43) Pub. Date: Dec. 26, 2013

(54) FILTER DESIGN AND PROCESS OF CAPTURING PARTICLES

(71) Applicant: LMS TECHNOLOGIES, INC., Bloomington, MN (US)

(72) Inventors: Kui-Chiu Kwok, Eden Prairie, MN (US); Ali Reza Vatine, Eden Prairie, MN (US)

(73) Assignee: LMS Technologies, Inc., Bloomington, MN (US)

(21) Appl. No.: 13/838,227

(22) Filed: Mar. 15, 2013

Related U.S. Application Data
(60) Provisional application No. 61/662,245, filed on Jun. 20, 2012.

(51) Int. Cl. B01D 46/52; B03C 3/34; B01D 53/22; B01D 46/00

(52) U.S. Cl. CPC B01D 46/521; B01D 46/00; B03C 3/34; B01D 53/22
USPC 95/273; 55/486; 96/17; 96/11

(57) ABSTRACT

Various embodiments disclose filtration apparatuses and processes for filtering particles from a particle-laden air stream. In one embodiment, a filter is provided with a front face layer, in which at least one impaction nozzle is formed, is to accelerate an air stream onto an interior substrate to capture large particle sizes with a calculated fractional efficiency. The interior substrate is formed within the filter. The filter further includes a rear face layer in which at least one opening is formed to exhaust the air stream. A filter media material may be placed between the front face layer and rear face layer. Other apparatuses and processes are disclosed as well.

### RELATED APPLICATION

This application claims priority benefit to U.S. Provisional Patent Application Ser. No. 61/662,245 entitled, “FILTER DESIGN AND METHOD OF MAKING SAME,” filed Jun. 20, 2012, which is hereby incorporated by reference in its entirety.

### BACKGROUND

Embodiments of the present invention relate generally to filters and methods for removing particulates from an air stream. The particulates can be dry, semi-dry, or wet.

Air born particulates, either occurring in nature or generated by humans, can have harmful effects on human beings, animals, and machines. Therefore, air filtration has been a very common but important method to remove these particulates. Existing air filters are fabricated from one or more filter media materials such as cotton, fabric, wool, polymer, fiberglass, ceramic, foam, metal, or others. These filter media can be thick or thin. In general, the filter media are designed to give a certain filtration efficiency, pressure drop, and dust holding capacity. High density, or low porosity, filter media gives high efficiency but also a high pressure drop and a low dust holding capacity. A high pressure drop may require larger fan motors to force the air steam through the filter and a resultant increased energy usage. A low dust holding capacity may require more frequent filter changes.

On the other hand, a high loft media has a large porosity which results in a low efficiency and low pressure drop but also a high dust holding capacity. Most thin media have a low porosity. Consequently, the thin media are generally pleated to increase filtration surface area to lower the pressure drop and to improve dust holding capacity.

As noted, air born particles can be dry, wet, or semi-dry. Most house-hold heating, ventilation, and air conditioning (HVAC) filters are designed to handle dry particles. Wet particles are generally liquid droplets. Examples of wet particles are water, oil, and paint. Semi-dry particles are mostly from a solution with a fast vaporizing solvent. An example of a semi-dry particle is fast drying paint.

Dry particles can bounce off from the fibers of the filter media and re-entrain themselves into the exhaust air stream, hence reducing efficiency and dust holding capacity of the filter media. Some high loft filters have a “tackifier” (e.g., an oil or adhesive) applied to the media to help capture and retain particles. In this case, the filtration efficiency of large particles generally improves moderately but the filtration efficiency does not generally increase for small particles by using a tackifier. For high density (low porosity) media, particles can deposit on the top surface, hence clogging the filter in a short time. This clogging condition is called face loading. Face loading causes a rapid increase in pressure drop, hence consuming more energy and shortening the service life of the filter.

A significant improvement in filter design for dry particles is the introduction of electrostatic media, in which the media are charged electrostatically. Small particles, once in close proximity to the charged fibers, are attracted and collected onto the charged fibers. Electrostatically charged media may significantly improve the filtration efficiency of small particles and reduce the pressure drop as compared with non-electrostatically charged media with a similar efficiency.

A filter used to capture semi-dry and wet particles is designed differently than a dry particle filter. Wet particles are generally sticky and adhere to the filter surface upon contact. The wet particles coalesce into a liquid film, which runs down on a vertically- or slantingly-mounted filter. However, the semi-dry particles have a very interesting deposition behavior. They are sticky, like liquid particles, but dry quickly and become semi-sticky. This semi-sticky characteristic causes incoming particles to accumulate on top of the particles already deposited. As time goes on, deposits of particles “grow” from the edge of an opening towards the center of the opening, thus making the opening smaller. These growing deposits eventually close out the airflow area and rapidly develop a higher pressure drop across the filter. In other words, the semi-drying particles can clog a filter very quickly and shorten the life of the filter.

It is well known in the filtration art that there are mainly three filtration mechanisms. They are impaction, interception (or straining), and diffusion. Impaction utilizes the inertial energy of the particles to impact the particles onto a substrate. Interception (or straining) basically intercepts particles with openings in a screen smaller than the particle size. Diffusion is only a significant particle capturing mechanism for very small particle sizes; for example, typically good for submicron particles. According to the American Society of Heating, Refrigerating, and Air-Conditioning Engineers (ASHRAE) 52.2 standard, “Method of Testing General Ventilation Air-Cleaning Devices for Removal Efficiency by Particle Size,” particle sizes to be considered for Minimum Efficiency Reporting Value (MERV) rating range from 0.3 micrometers (μm) to 10 μm. Therefore, all three filtration mechanisms must be employed in order to effectively capture all particle sizes in this size range.

To handle paint particles, U.S. Pat. Nos. 3,075,337 and 6,790,397 each discuss a paint filter made of two folded papers to form inlet and exhaust walls, in which openings are formed to let the air stream in and out of the filter. The paint filters discussed in these patents utilize impaction as the primary filtration mechanism and can only handle wet particles with low efficiency, with an especially poor efficiency for small particles.

U.S. Pat. No. 6,071,419 discusses examples of filtering wet, dry, or semi-dry particles using high-loft media. This particular design with the high-loft media is for handling semi-dry paint which can clog most filters quickly. Initially, large paint particles impact onto the surface directly facing the incoming air stream, which quickly clogs the filter surface. Smaller particles then enter into the media through the vertical side walls. Some of these small particles are captured by the fibers of the media. The patent further discusses a filter design that utilizes both impaction and interception mechanisms. However, the impaction mechanism is not intentionally controlled. According to impaction theory, briefly discussed herein, impaction velocity and nozzle size are important to affect the collection efficiency of particles. Therefore, the patented filter design discussed in the '419 patent is only designed for high paint holding capacity but not for high initial efficiency.

### BRIEF DESCRIPTION OF THE DRAWINGS

FIG. 1A shows a basic filter design and construction according to various embodiments;

FIG. 1B shows a cross-sectional view an embodiment of the filter design with a filter media placed between inlet and exit openings in accordance with various embodiments;

FIG. 2A shows a cross-sectional view of an embodiment of a filter design with a filter media placed adjacent to inlet and exit openings in accordance with various embodiments;

FIG. 2B shows a cross-sectional view of an embodiment of a filter design with a filter media placed on interior walls opposite the inlet and exit openings in accordance with various embodiments;

FIG. 2C shows a cross-sectional view of an embodiment of a filter design with a filter media placed adjacent to the exit openings in accordance with various embodiments;

FIG. 3A shows cavities created within a filter design according to various embodiments;

FIG. 3B shows the paths and particle capture of various sizes of particles that traverse the filter design of FIG. 3A;

FIG. 3C shows the coalescence of liquid particles and a drainage channel in the filter design of FIG. 3A;

FIG. 4 shows illustrative three-dimensional drawings with agglomerated semi-dry particles on a filter according to various embodiments discussed with reference to FIG. 3A and FIG. 3B;

FIG. 5 shows an illustrative three-dimensional drawing of air flow redistribution within a filter;

FIG. 6A shows a cross-sectional view of an embodiment of a filter design having hidden inlet openings;

FIG. 6B shows a cross-sectional view of a variation of the filter design of FIG. 6A;

FIG. 7 through FIG. 9 show cross-sectional views of additional embodiments of filter designs having hidden inlet holes including a design having curved filter walls (FIG. 7), rectangular-shaped filter walls (FIG. 8), and diamond-shaped filter walls (FIG. 9);

FIG. 10 shows a cross-sectional view of an embodiment of a filter design having an inverted “V” shape;

FIG. 11A and FIG. 11B each show a cross-sectional view of an embodiment of a filter design having stacked rectangular features with either hidden or a combination of hidden and unhidden inlet holes; and

FIG. 12 shows an illustrative three-dimensional drawing of an embodiment of a diffusion media design.

### DETAILED DESCRIPTION

Atmospheric or human-generated particles can be solid, liquid, or some combination of the two types. Certain types and concentrations of particles can be hazardous to human health. Thus, particles frequently need to be removed in many residential, commercial, and industrial applications. For example, air filtration for engines, clean rooms in semiconductor fabrication facilities, hospitals, surgical rooms, office buildings, and so on need to have particles removed to function properly or more efficiently. The particle range of general interest for these various applications may extend from less than about 0.1 μm up to 1 mm or greater.

Minimizing energy consumption is an important and major factor for all filtration applications and devices. Typical filtration methods and devices use a media with certain pore sizes to intercept particles while allowing air to pass through. All filters or filtration methods are rated by three performance parameters: collection efficiency, pressure drop, and particle holding capacity. Collection efficiency is a function of particle size and is referred to as fractional efficiency.

Based on testing standards established by ASHRAE, a filter may be rated by using a range of challenge particle sizes from 0.3 μm to 10 μm. A high-efficiency filter (e.g., a high-efficiency particulate air (HEPA) filter) will have a minimum particle efficiency of 99.997% of particle collection efficiency at 0.3 μm at a given face velocity (the velocity of the incoming air stream normal to the filter). To reduce energy consumption, the filtration industry desires a filter with high fractional efficiency and holding (e.g., retention or loading) capacity at the lowest possible pressure drop. The holding capacity determines the service life and hence the cost of filter usage over time.

Various embodiments described herein provide a novel filter design and process to improve the efficiency, reduce the pressure drop, and increase the dust holding capacity for all types of particles: dry, semi-dry, and wet. As described in more detail below, various embodiments of the present invention described and shown generally comprise a top wall (or entrance wall), a high loft media, and a bottom wall (or exit wall). The high loft media is placed between the two walls. In various embodiments, the placement of the high loft media may form a space between the top wall and the bottom wall. In various embodiments, a space may be formed between the media and the bottom wall. The top and bottom walls may be impermeable, semi-permeable, or permeable, depending on the type of gas or air and the magnitude of pressure applied. There are holes (openings) on both the top and bottom walls. The holes on the top wall may be considered in some embodiments as impaction nozzles. These holes are designed to control the impacting velocity of the particle and air stream onto the media inside the filter. The holes on the bottom wall are designed to control the exiting velocity and re-distribution of the air stream. If present, the spaces formed above and below the high loft media are designed to re-distribute the air stream so an increased surface area of the high loft media can be used for filtration.

In various embodiments, a controlled impaction mechanism on the entrance wall of a filter is disclosed. The controlled impaction mechanism is based on impactor theory. In various embodiments, a filter that has high filtration efficiency and high loading capacity at low pressure drop is disclosed. In various embodiments, a filter than can serve to capture dry, semi-dry, or wet particles is disclosed. In various embodiments, a diffusion filter that can capture particles as well as diffuse an incoming air stream to a uniform air stream with laminar flow and at low velocity is disclosed. In various embodiments, a process that collects largest particles first, then medium particles next, and finally the smallest particles, is disclosed.

Various filter designs and filtration processes are described herein that separate, capture, and retain particles from a particle-laden air stream or air flow. In various embodiments, the filter design may comprise three layers of materials, a number of nozzles or inlet openings, one or more impaction substrates or surfaces, one or more cavities, and one or more exit openings. The particle-laden air stream may accelerate through a nozzle or inlet opening and enter into a cavity to impact onto an interior wall of the filter or a filter media. The filter media may be treated (e.g., with a tackifier or electrostatically) or untreated. Due to the filter design, larger particles may be captured and retained within the filter. The air stream then passes through the filter media that further captures smaller particles. Clean air may exhaust either through a cavity or directly to the exit opening.

In general, a determination of what particle sizes may be impacted and what particle sizes will follow the air stream or streamlines may be determined theoretically by equation (1), known as the Stokes Equation;

$${D}_{p} = \sqrt{\frac{9 ( {μ}_{air} ) ( W ) ( Stk )}{( {ρ}_{p} ) ( {v}_{o} ) ( {C}_{c} )}} \qquad ( 1 )$$

where Dₚ is the particle cutoff-diameter, μₐᵢᵣ is the viscosity of air, W is the nozzle or opening width or diameter, Stk is the Stokes number (the ratio of the stopping distance of a particle to some characteristic dimension of the obstacle such as the distance from the opening to an interior wall of the filter or the filter media), and C_{c} is the Cunningham slip correction factor (to account for non-continuum effects when calculating the drag force on small particles). In various embodiments, the nozzle or opening may be round, rectangular, triangular, slot, or a variety of other geometrical shapes or a combination of shapes.

The filter media (e.g., the high loft media) can be tackified by liquid, oil, adhesive, or other appropriate coating, such as nano-fibers. Also, electrostatic charging of the filter media can be applied to enhance capturing of small particles.

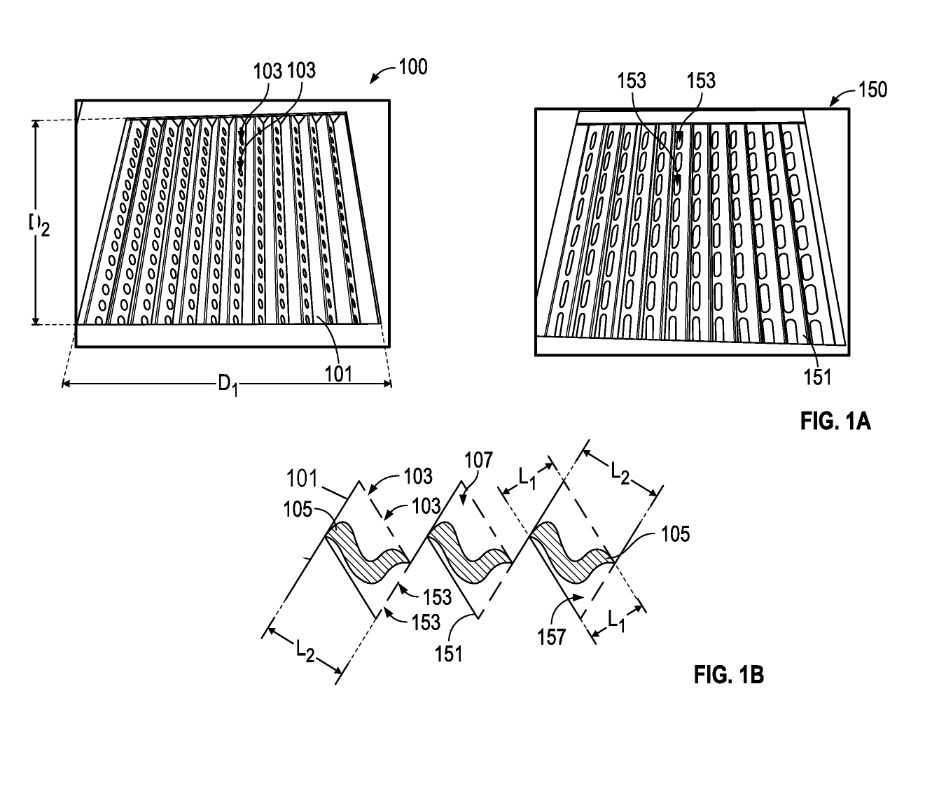

With reference now to FIG. 1A, a basic filter design and construction according to various embodiments is shown. A top plan view 100 and a bottom plan view 150 of a basic filter are shown. The basic filter may have various dimensions when used in various industries and applications. For example, in a standard HVAC application for an office filtration application, the dimensions D₁ and D₂ may each be about 508 mm in size (approximately 20 inches). In other examples, each dimension may be larger or smaller than 500 mm. Also, the dimensions D₁ and D₂ may each be different. For example, in certain applications, D₁ may be 406 mm (approximately 16 inches) and D₂ may be 610 mm (approximately 24 inches).

The basic filter of FIG. 1A may comprise three layers of materials. For example, a front face layer 101 of the basic filter is shown to have a number of inlet openings 103. Similarly, a rear face layer 151 of the basic filter is shown to also have a number of outlet openings 153. The total number of the inlet openings 103 and the outlet openings 153 may be the same or different. Also, the sizes (e.g., open area) of the inlet openings 103 and the outlet openings 153 may be the same or different as described herein.

The front face layer 101 and the rear face layer 151 comprises one or materials that may be impermeable, semi-impermeable, or permeable to gas or liquid. The middle layer (not shown in FIG. 1A but described in more detail below) may comprise a permeable material that is more permeable relative than the front face layer 101 and the rear face layer 151. The permeability of a material depends on the gas or liquid and the pressure applied thereto. For example, common cardboard paper is normally considered as impermeable to air under a pressure of a few Torr (e.g., a few inches of water of water column). However, a thin aluminum can is permeable to carbon dioxide gas under high pressure.

Material selections for the permeable media can include, for example, a screen made of polymer, metallic, or non-metallic wires, a membrane made of cellulose or polymer, a woven cloth or fabric made of cotton, high-loft non-woven polymer, glass fibers, foam, porous ceramic, steel or bronze wool pads, and a number of other materials known independently in the art.

In addition to selecting one or more of the materials above for the permeable media, the permeable media can be also enhanced to improve filtration efficiency by “tackifying” the media with oils, adhesives, or other liquids. In addition, high loft media can also be enhanced by embedding nano-fibers or imparting electrostatic charges to the fibers.

The filter may either be pleated or not pleated. A pleated filter design increases the surface area for filtration and forms troughs for liquid drainage (discussed in more detail, below). Holes or slots for the inlet openings 103 and the outlet openings 153 may be punched or otherwise formed on the pleated surfaces or non-pleated surfaces both on the front face layer 101 and the rear face layer 151 of the filter. The front face layer 101 (or first side) of the filter is generally the airflow entrance side; and the rear face layer 151 (or second side) is the airflow exit side, as shown in FIG. 1B.

FIG. 1B shows a cross-sectional view an embodiment of the filter design with a filter media material 105 placed between inlet openings 103 and outlet openings 153 in accordance with various embodiments. FIG. 1B also shows a filter design in which a first cavity 107 is formed between the front face layer 101 and the filter media material 105. A second cavity 157 is formed between front face layer 101 and the filter media material 105. The filter media material 105 may be comprised of any of the permeable materials described herein or otherwise known in the art. Additionally, the filter media material 105 may be held in place between the front face layer 101 and the rear face layer 151 by friction or may otherwise be adhered by, for example, chemical or mechanical means.

In one embodiment, the length, L₁, of the front face layer 101 may be the same as the length, L₂, of the rear face layer 151. In other embodiments, the lengths L₁ and L₂ may be different.

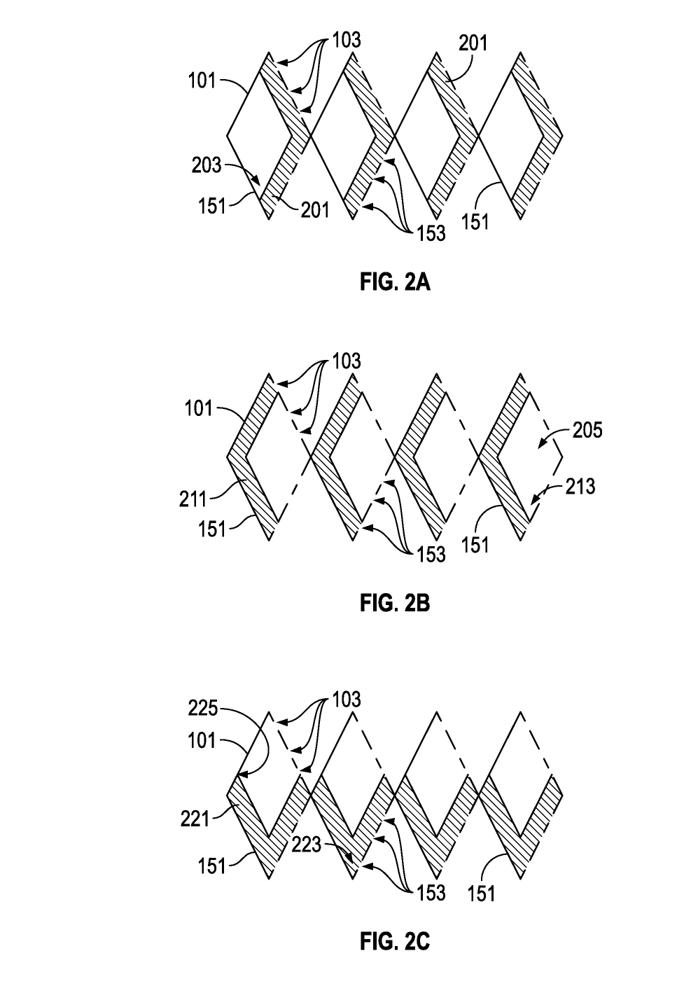

Even though one embodiment of the filter is described above, the placement of filter media material inside the filter can be formed or placed in several ways, such as those shown in FIG. 2A through FIG. 2C. Even though each of these figures is described separately, a person of ordinary skill in the art will recognize upon reading and understanding the disclosure provided herein, that various ones of the individual figures may be combined. This variety of placement positions for the filter media has various functions for specific filtration requirements, as described below.

FIG. 2A shows a cross-sectional view of an embodiment of a filter design with a filter media material 201 placed adjacent to the inlet openings 103 and the outlet openings 153 in accordance with various embodiments. The filter media material 201 may be any of the permeable media discussed herein.

The filter design of FIG. 2A further shows a trough 203 formed near an intersection of a lower portion of the filter media material 201 and the rear face layer 151. The trough 203 may be used to coalesce and capture liquid droplets such as water and liquid particles. For example, as explained in more detail below, larger liquid droplets may impact onto various outside surfaces (e.g., the front face layer 101) or inside surfaces (e.g., an interior portion of either the front face layer 101 or the rear face layer 151) of the filter. As the liquid droplets are impacted, they may be coalesced into a liquid film which runs down one or more “V” troughs formed external to the filter (not shown in FIG. 2A but readily understood by a person of ordinary skill in the art). The person of ordinary skill in the art will further recognize that the “V” trough is only one example of various troughs or channels that may be employed. Other geometries of the trough include, for example, a “C,” “U,” or other shapes to direct flow of the coalesced film or other fluids. Smaller droplets may be coalesced by the filter media material 201 at the inlet openings 103. In this case, the collected liquid runs down inside the filter and along the filter media material 201 in the trough 203 to the external “V” trough for drainage.

FIG. 2B shows a cross-sectional view of an embodiment of a filter design with a filter media material 211 placed on interior walls of the front face layer 101 or the rear face layer 151 opposite the inlet openings 103 and the outlet openings 153 in accordance with various embodiments.

FIG. 2B has some functions similar to that of FIG. 2A. However, liquid droplets in FIG. 2B may travel inside the filter and impact onto the filter media material 211. The liquid droplets then coalesce into a film or liquid that runs down to a trough 213 formed near an intersection of a lower portion of the filter media material 211 and the rear face layer 151. The film or liquid may then travel to a bottom “V” trough, external to the filter, for drainage. The filter design of FIG. 2B also can effectively capture dry and semi-dry particles. Furthermore, the filter design of FIG. 2B has an inherent property that the pressure drop will typically not increase due to collection of a large amount of particles. The reason for the consistent pressure drop is that air can flow freely from the inlet openings 103 to the exit openings inside an open cavity 205 formed on the interior of the filter, above the trough 213.

FIG. 2C shows a cross-sectional view of an embodiment of a filter design with a filter media material 221 placed adjacent to the outlet openings 153 in accordance with various embodiments. Although FIG. 2C shows the filter media material 221 arranged on a back interior wall of the filter (opposite the inlet openings 103), a person of ordinary skill in the art will recognize that placing the filter media material 221 near only the outlet openings 153 may also be a suitable arrangement.

FIG. 2C also has various filtration properties. For example, particles in an air stream passing through the inlet openings 103 may impact onto the opposite surface (depending upon face velocity of the air stream and other factors discussed herein). For dry and semi-dry particles, the particles may be collected near a junction 225 of the interior of the front face layer 101 and the filter media material 221. Smaller particles that have escaped impaction on the junction 225 may be captured by a portion of the filter media material 221 covering the outlet openings 153. Similar to the process described above with reference to FIG. 2A and FIG. 2B, liquid droplets may be coalesced at a trough 223 located at a lowermost portion of the filter media material 221 and an interior wall of the rear face layer 151. The liquid droplets may then travel through to a “V” trough (not shown in FIG. 2C), external to the filter, for drainage. A portion of the filter media material 221 covering the outlet openings 153 may further coalesce and collect smaller size droplets for drainage to the trough 223.

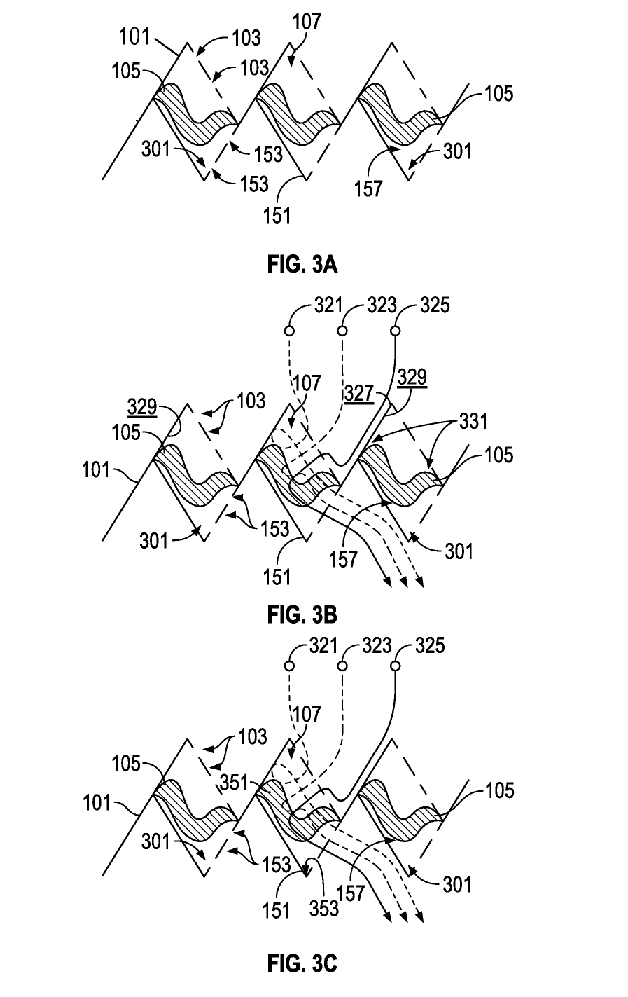

With reference now to FIG. 3A, cavities created within a filter design according to various embodiments are shown. Specifically, the first cavity 107 and the second cavity 157 are formed by the filter media material 105 separating interior portions of the filter between the front face layer 101 and the rear face layer 151. FIG. 3A further shows a trough 301 in which coalesced liquid droplets may be collected and travel through the filter to an external “V” trough (not shown in FIG. 3A).

FIG. 3B shows the paths and particle capture of various sizes of particles that traverse the filter design of FIG. 3A. In a specific example embodiment, FIG. 3B shows streamlines of particle-laden air streams to illustrate the successive processes of capturing particles including small particle sizes 321, medium particle sizes 323, and large particle size 325; that is, the various line types shown indicate the paths of the small particle sizes 321, the medium particle size 323, and the large particle sizes 325. A skilled artisan will recognize that the relative terms, “small,” “medium,” and “large,” are given with regard to the particle size ranges discussed above (e.g., 0.3 μm to 10 μm) and are provided to provide additional insight into the particle capture mechanisms, as discussed herein.

As particles of a wide range of sizes (e.g., 0.3 μm to 10 μm) coming to the filter in an air stream, the large particle sizes 325, having more inertia for a given face velocity, will impact onto outer surfaces 327 of the filter, as shown by the solid line. For dry particles, most of the large particles may bounce off from the outer surface 327. If the particles are semi-dry or wet, they may stick to the outer surface 327 and be removed from the air stream.

Particle impaction on the outer surfaces 327 is the first capture mechanism or portion of the filtration process. Particles that are not impacted on the outer surface 327 enter the filter through the inlet openings 103. Each of the inlet openings 103, the first cavity 107, and a surface of the interior wall 329 form a subsequent level of impaction; the next impactor. The inlet openings 103 are designed to accelerate the particles to a higher velocity (relative to the face velocity of the incoming particle-laden air stream) for impaction. A calculation of a size (e.g., diameter) of the inlet openings 103 may be performed in accordance with the Stokes equation, described above.

The first cavity 107 can be designed to allow additional time for developing a higher air velocity through the filter after the air stream has entered through the inlet openings 103. As discussed above, the interior wall 329 of the front face layer 101 forms an impaction substrate. Since various size regimes (e.g., small, medium, and large particle sizes) have different inertia for a given face velocity, the design and placement of the inlet openings may be sized appropriately to increase the efficiency with which each particle size regime (e.g., smaller particle sizes) are captured.

Based on the impactor theory, described above, the hole-size of the inlet openings 103 can be designed to have an effective cutoff size for particles of a given size (e.g., a diameter of a spherical particle). The effective cutoff size means that particles larger than or equal to that size will be captured by the impaction substrate.

Assuming that the particles do not bounce from the substrate, a smaller hole-size has a higher collection efficiency of particles due to an increased air stream velocity and a resultant thinner hydrodynamic boundary layer formed on the substrate. That is, particles will tend to pass through a thinner hydrodynamic boundary layer onto the impaction substrate and not be carried along with the air stream.

Furthermore, a high impaction velocity is desirable to capture small particles. However, a higher impaction velocity requires smaller and fewer holes (e.g., the inlet openings 103), which creates a higher pressure drop across the filter. In order to balance the requirements of high impaction velocity and low pressure drop, a hole size of the inlet openings 103 and a total numbers of the inlet openings 103 for the filter must be selected. Further, the placement of the inlet openings 103 on the front face layer 101 of the filter may be selected to direct particles to a desirable location inside the filter.

For example, it may be better to direct dry particles towards an intersection between the interior wall 329 and the filter media material 105 where a particle trap 331 is formed. The particle trap 331 can store a large amount of captured particles without increasing the pressure drop across the filter. Semi-dry and wet particles can be directed to impact on a solid wall (e.g., the interior wall 329) or the particle trap 331 because particle bounce is much less of an issue with semi-dry and wet particles as compared with dry particles. Therefore, the impaction of the air stream onto the interior wall 329, acting as an impaction substrate, of the filter is the second process of filtration that captures particles of smaller sizes.

The third process of filtration in the filter designs disclosed herein is the capturing of smallest particles by the filter media material 105. The filtration efficiency of the filter media material 105 can be enhanced by adding a tackifier, such as oil or adhesive, as discussed above. Also, the embedment of nano-fibers and electrostatically charging high loft fibers will significantly improve efficiency of small particles.

The process described above of filtering particles from large to small successively provides a novel process to significantly improve collection efficiency and increase dust holding capacity combined with a low pressure drop.

FIG. 3C shows the coalescence of liquid particles and a drainage channel 353 in the filter design of FIG. 3A. Also, the filter media material 351 may be one or more of the various permeable media materials discussed. Additionally, the filter media material 351 may be combined with a tackifier, nano-fibers, electrostatic charging, or any combination thereof.

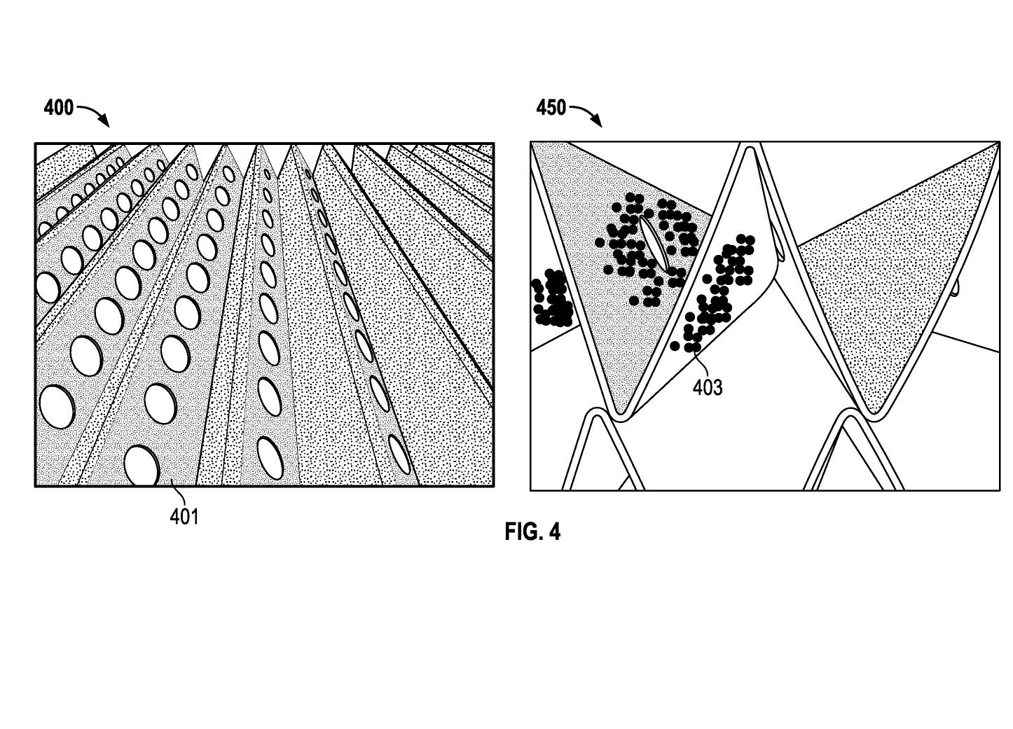

FIG. 4 shows illustrative three-dimensional drawings with agglomerated semi-dry particles of a filter according to various embodiments discussed with reference to FIG. 3A and FIG. 3B. FIG. 4 provides a visual supplement to the impaction discussion with reference to FIGS. 3A and 3B, above. The three-dimensional drawing of an exterior view 400 of the filter (specifically, the front face layer 101) shows accumulated deposits (indicated by light and dark areas of “stippling”) of, for example, dry paint particles 401 around the inlet openings 103 (FIG. 3A) and along the ridge of the pleats on the front face layer 101 (see the top plan view 100 of FIG. 1A). Also, in the three-dimensional drawing of an interior view 450 of the filter, additional heaps of dry paint particle deposits 403 can be seen on an interior wall 329 (FIG. 3B) opposite to the inlet openings 103. These drawings illustrate the peculiar deposition behavior of, for example, semi-dry paint.

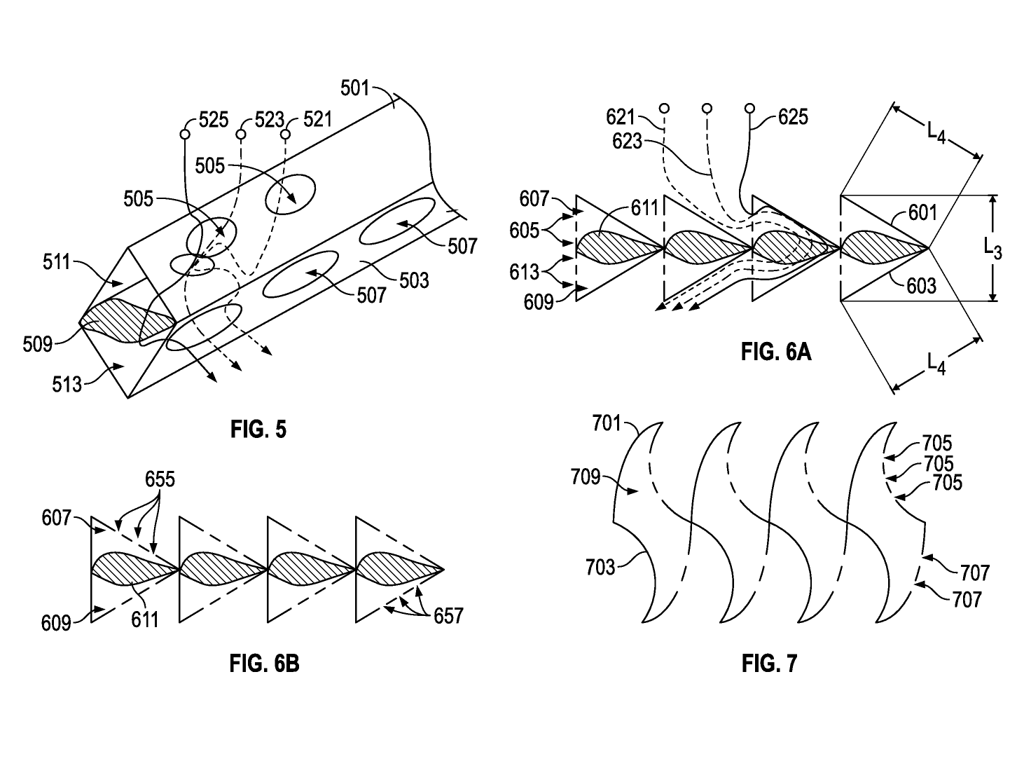

FIG. 5 shows an illustrative three-dimensional drawing of air flow redistribution within a filter. FIG. 5 is shown to include a front face layer 501, a rear face layer 503, a number of inlet openings 505, a number of outlet openings 507, and a filter media material 509. Each of these materials may be similar or identical to the materials used for related areas discussed herein.

FIG. 5 further shows streamlines of particle-laden air streams to illustrate the successive processes of capturing particles including small particle sizes 521, medium particle sizes 523, and large particle size 525; that is, the various line types shown indicate the paths of the small particle sizes 521, the medium particle size 523, and the large particle sizes 525. The behavior of these various particle sizes may be similar to the particle sizes discussed above with reference to FIG. 3B.

A top cavity 511 formed between the filter media material 509 and the front face layer 501 provides a space for an incoming air stream to flow to other surfaces within the filter should certain portions of the filter media material 509 become clogged. Similarly, a bottom cavity 513 formed between the filter media material 509 and the rear face layer 503 also provides space for an air stream to flow out of the filter with a reduced flow impedance.

To capture semi-dry and wet particles, hidden inlet holes may be beneficial, especially for capturing particles generated by spraying fast drying paints. FIG. 6A shows a cross-sectional view of an embodiment of a filter design having a number of hidden inlet openings 605. FIG. 6A is further shown to include a front face layer 601, a rear face layer 603, a number of outlet openings 613, and a filter media material 611. Each of these materials may be similar or identical to the materials used for related areas discussed herein.

A top cavity 607 formed between the filter media material 611 and the front face layer 601 provides a space for an incoming air stream to flow to other surfaces (e.g., into or out of the plane of the paper) within the filter should certain portions of the filter media material 611 become clogged. Similarly, a bottom cavity 609 formed between the filter media material 611 and the rear face layer 603 also provides space for an air stream to flow out of the filter with a reduced flow impedance. The bottom cavity 609 may also be used as a trough to conduct coalesced droplets or films out of the filter.

At least one advantage of the design of the filter shown in FIG. 6A, as compared with other designs, is that the amount of material used for construction of the pleated filter (e.g., the front face layer 601 and the rear face layer 603) per pleat is reduced. For example, with reference again to FIG. 1B, a pleated filter may have an equal length, L₁ and L₂, on both sides of the pleat. In contrast, the filter of FIG. 6A has a short vertical length, L₃, and a long slant length, L₄. Consequently, the total length (L₃+2L₄) used to make such a pleat is shorter than that length (2L₁+2L₂) used to make a regular pleat in a filter. In other embodiments, the lengths L₃ and L₄ may also be approximately equal in length.

Referring again to FIG. 6A, streamlines of particle-laden air streams are shown to illustrate the successive processes of capturing particles including small particle sizes 621, medium particle sizes 623, and large particle size 625; that is, the various line types shown indicate the paths of the small particle sizes 621, the medium particle size 623, and the large particle sizes 625. The behavior of these various particle sizes may be similar to the particle sizes discussed above with reference to FIG. 3B.

FIG. 6B shows a cross-sectional view of a variation of the filter design of FIG. 6A. In FIG. 6B, a number of inlet openings 655 and a number of outlet openings 657 have been repositioned to the front face layer 601 and the rear face layer 603, respectively.

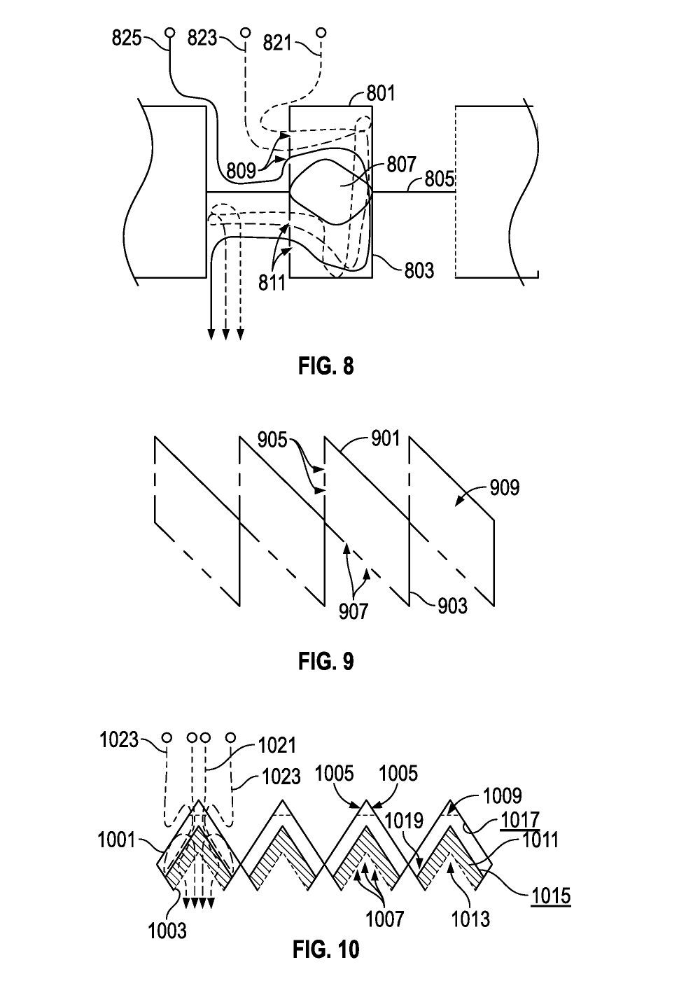

FIG. 7 through FIG. 9 show cross-sectional views of additional embodiments of filter designs having hidden inlet holes including a design having curved filter walls (FIG. 7), rectangular-shaped filter walls (FIG. 8), and diamond-shaped filter walls (FIG. 9). The hidden holes in each of these designs reduce the amount of agglomeration of paint, or other semiconductor-dry or wet particles, around the inlet holes, hence reducing the risk of filter clogging.

For example, with direct reference to FIG. 7, a front face layer 701 and a rear face layer 703 have a cavity 709 formed therebetween. A number of inlet openings 705 and a number of outlet openings 707 are formed within the front face layer 701 and the rear face layer 703, respectively. Although not shown explicitly, a person of ordinary skill in the art will recognize that a filter media material (e.g., the filter media material 611 of FIG. 6A) may be placed within the cavity 709.

FIG. 8 is shown to include a front face layer 801 and a rear face layer 803 forming a series of rectangular elements. Each of the series of rectangular elements is connected by a web 805. (A skilled artisan will recognize that the rectangular design is merely exemplary but other shapes, such as various forms of polygons, may be used.) The web 805 may be formed from the same or a similar material used to form the front face layer 801 or the rear face layer 803 A number of inlet openings 809 and a number of outlet openings 811 are formed within the front face layer 801 and the rear face layer 803, respectively. A filter media material 807 is positioned between the front face layer 801 and the rear face layer 803.

FIG. 8 further shows streamlines of particle-laden air streams to illustrate the successive processes of capturing particles including small particle sizes 821, medium particle sizes 823, and large particle size 825; that is, the various line types shown indicate the paths of the small particle sizes 821, the medium particle size 823, and the large particle sizes 825. The behavior of these various particle sizes may be similar to the particle sizes discussed above with reference to FIG. 3B.

FIG. 9 is shown to include a front face layer 901 and a rear face layer 903 have a cavity 909 formed therebetween. A number of inlet openings 905 and a number of outlet openings 907 are formed within the front face layer 901 and the rear face layer 903, respectively. Although not shown explicitly, a person of ordinary skill in the art will recognize that a filter media material (e.g., the filter media material 611 of FIG. 6A) may be placed within the cavity 909.

Referring now to FIG. 10, a cross-sectional view of an embodiment of a filter design having an inverted “V” shape 1013 is shown. FIG. 10 is shown to include a front face layer 1001, a rear face layer 1003, a number of hidden inlet openings 1005, a number of outlet openings 1007, and a filter media material 1011. A number of secondary hidden inlet openings 1009 are formed within the filer and proximate to an uppermost portion of the front face layer 1001. Each of these materials may be similar or identical to the materials used for related areas discussed herein.

The hidden inlet openings 1005 may or may not be located directly above respective ones of the outlet openings 1007. In various embodiments, the hidden inlet openings 1005 are offset into or out of the plane of the paper from the outlet openings 1007 to avoid a short-circuited air stream flow from inlet to outlet.

FIG. 10 further shows streamlines of particle-laden air streams to illustrate the successive processes of capturing particles including small particle sizes 1023 and larger particle sizes 1021; that is, the various line types shown indicate the paths of the small particle sizes 1023, and the larger particle sizes 1021. The behavior of these various particle sizes may be similar to the particle sizes discussed above with reference to FIG. 3B and is discussed in further detail, below.

The inverted “V” 1013 of the bottom wall acts as an impaction substrate. Moreover, an interior surface 1017 of the front face layer 1001 and an uppermost portion 1015 of the filter media material 1011 may act as additional impaction surfaces. In the case of the uppermost portion 1015, filter media material 1011 allows the incoming air to penetrate therein to capture the larger particle sizes 1021 by impaction. The inverted “V” 1013 also splits the incoming flow into two parts; both parts flowing down along the slopes of the inverted “V” 1013 toward an intersection 1019 formed by the filter media material 1011 and the interior surface 1017 of the front face layer 1001. Depending on the velocity of the air stream through the filter, the rough surfaces of the filter media material 1011 may generate a turbulence boundary layer which in turn causes some particles to be captured by the filter media material 1011. Large and re-entrained particles and agglomerates of particles may be pushed into the intersection 1019, wherein these particles may be trapped permanently. After hitting the intersection 1019, the air stream carrying the small particle sizes 1023 turns around and flows towards the outlet openings 1007. Especially if the filter media material 1011 is tackified, the filter media material 1011 will capture the small particle sizes 1023 before letting the air stream out of the outlet openings 1007.

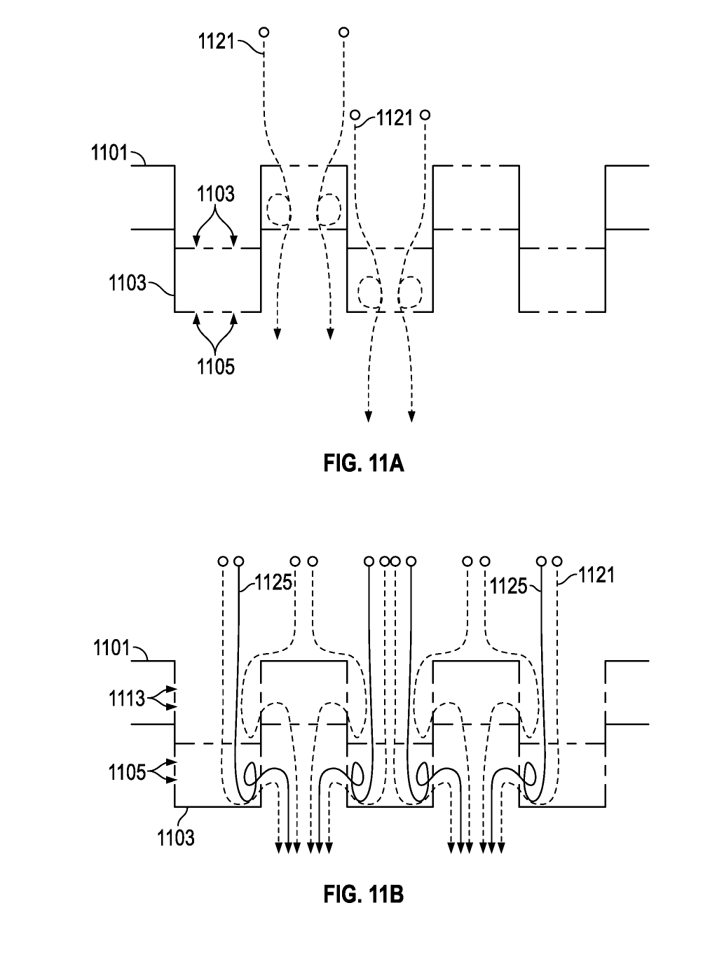

FIG. 11A and FIG. 11B each show a cross-sectional view of an embodiment of a filter design having stacked rectangular features with either hidden or a combination of hidden and unhidden inlet holes. For example, FIG. 11A is shown to include a front face layer 1101, a rear face layer 1103, a number of inlet openings 1105, and a number of outlet openings 1107. Although not shown explicitly in FIG. 11A, a person of ordinary skill in the art will recognize, upon reading and understanding the disclosure provided herein, that a filter media material may be formed between the number of inlet openings 1105 and the number of outlet openings 1107. Each of these materials may be similar or identical to the materials used for related areas discussed herein.

As disclosed with reference to FIG. 10, above, the inlet openings 1105 and the hidden inlet openings 1113 may or may not be located directly above respective ones of the outlet openings 1107. In various embodiments, the inlet openings 1105 and the hidden inlet openings 1113 are offset into or out of the plane of the paper from the outlet openings 1107 to avoid a short-circuited air stream flow from inlet to outlet.

FIG. 11B illustrates a filter with the same or similar cross-section as that described with reference to FIG. 11A, but FIG. 11B includes a number of hidden inlet openings 1113. The outlet openings 1107 are relocated to a side portion of the rear face layer 1103. As with FIG. 11A, a person of ordinary skill in the art will recognize, upon reading and understanding the disclosure provided herein, that a filter media material may be formed between the number of hidden inlet openings 1113 and the number of outlet openings 1107. The skilled artisan will further recognize that various combinations of FIGS. 11A and 11B may be used in combination with one another.

FIGS. 11A and 11B further show streamlines of particle-laden air streams to illustrate the successive processes of capturing particles including small particle sizes 1121 and larger particle sizes 1125; that is, the various line types shown indicate the paths of the small particle sizes 1121, and the larger particle sizes 1125. The behavior of these various particle sizes may be similar to the particle sizes discussed above with reference to FIG. 3B.

Various embodiments of the disclosed subject matter can also be designed into a diffusion media. One function of a diffusion media is to capture particles and at the same time to diffuse a concentrated air stream evenly across the whole working area. For example, in the spray painting industry, such as in an automotive repair shop or in a car painting booth, require uniform and laminar flow within the work area. The airflow in the work area is generally either down-drafted or horizontally-drafted. An air velocity is generally maintained between about 30 meters per minute and about 45 meters per minute (approximately 100 feet per minute to 150 feet per minute) flowing downward or horizontally. The laminar flow requirement is to assure little disturbance to spray painting processes.

In a typical downdraft booth for spray painting operation, air is supplied by a blower at a location above the booth. The concentrated air flow generated by the blower is generally distributed evenly across the whole work area. The existing practice to assure even air flow involves employing a very dense media to diffuse the airflow. Since the air supply is concentrated at one location, in order to diffuse that air stream, high density pads at provided at the air supply location. Then lower density pads are arranged in such a way such that the pad density decreases as it is further away from the air supply location.

In various ones or combinations of the embodiments provided herein, the disclosed subject matter can be designed into an improved diffusion media having a lower pressure drop than that provided by the prior art. For example, one method utilizes many small holes to control the distribution of air flow. The hole size, hole quantity, and hole pattern can be designed to diffuse the concentrated air stream over a large working area. Since hole size and hole pattern can be precisely made on the top and bottom of impermeable surfaces, a uniform laminar flow is achieved to cover the whole working area. In order to cover a very large working area, many panels of these diffusion media, of appropriate size or sizes, may be constructed.

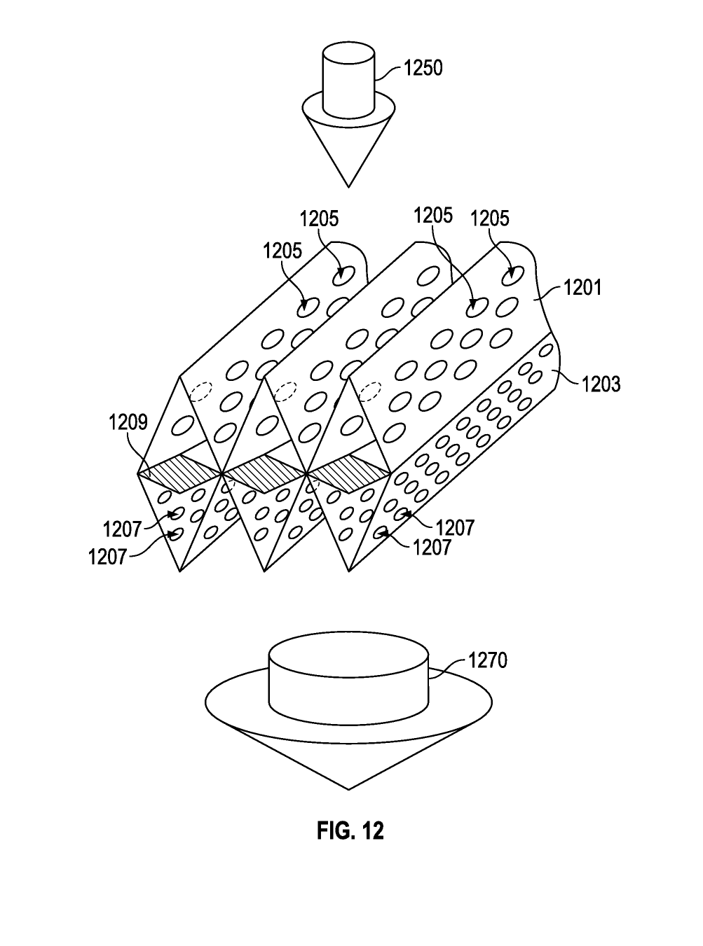

FIG. 12 shows an illustrative three-dimensional drawing of an embodiment of a diffusion media design. FIG. 12 is shown to include a front face layer 1201 to receive an incoming air stream 1250, a rear face layer 1203 to convey a uniform outgoing air stream 1270, a number of inlet openings 1205, and a number of outlet openings 1207. A person of ordinary skill in the art will recognize, upon reading and understanding the disclosure provided herein, that a filter media material 1209 may be formed between the number of inlet openings 1205 and the number of outlet openings 1207. However, the filter media material 1209 is not required to diffuse the air stream. Each of these materials may be similar or identical to the materials used for related areas discussed herein. As shown in FIG. 12, the number of inlet openings 1205 and the number of outlet openings 1207 are different sizes and of a different total number. However, based on the disclosure provided herein, the total number and sizes of the openings, relative to one another, may vary or may be the same.

Furthermore, even though all the filter designs described herein are defined in terms of single-stage filters, more than one filter can be integrated or stacked together in air stream series (e.g., a first filter stage upstream to a second or subsequent filter stage) to make a multi-stage filter. For example, for filtration processes in a three-stage multi-stage filter, the first stage can be designed to capture large particles, followed by the second stage that is designed to capture smaller particles, and then the last stage is designed to capture the smallest particles. Each of the inlet openings 103 and outlet openings 153 (see FIG. 3A), on subsequent stages of filtration, may be designed to have either increasingly smaller sizes of openings, or numbers of openings, or both, to further accelerate particles from one filter stage to the subsequent filter stage.

A person of ordinary skill in the art will appreciate that, for this and other methods and apparatuses disclosed herein, the activities forming part of various methods may be implemented in a differing order, as well as repeated, executed simultaneously, or substituted one for another. Further, the outlined acts and operations are only provided as examples, and some of the acts and operations may be optional, combined into fewer acts and operations, or expanded into additional acts and operations without detracting from the essence of the disclosed embodiments.

The present disclosure should not be construed to be limited in terms of the particular embodiments described in this application, which are intended as illustrations of various aspects of the apparatuses. Many modifications and variations can be made, as will be apparent to a person of ordinary skill in the art upon reading and understanding the disclosure. Functionally equivalent methods and apparatuses within the scope of the disclosure, in addition to those enumerated herein, will be apparent to a person of ordinary skill in the art from the foregoing descriptions. Portions and features of some embodiments may be included in, or substituted for, those of others. Many other embodiments will be apparent to those of ordinary skill in the art upon reading and understanding the description provided herein. Such modifications and variations are intended to fall within a scope of the appended claims. The present disclosure is to be limited only by the terms of the appended claims, along with the full scope of equivalents to which such claims are entitled. It is also to be understood that the terminology used herein is for the purpose of describing particular embodiments only and is not intended to be limiting.

Moreover, the description provided herein includes illustrative apparatuses (e.g., devices, structures, systems, and the like) and methods (e.g., processes, sequences, techniques, and technologies) that embody various aspects of the subject matter. In the detailed description, for purposes of explanation, numerous specific details are set forth in order to provide an understanding of various embodiments of the subject matter. It will be evident, however, to those skilled in the art that various embodiments of the subject matter may be practiced without these specific details. Further, well-known apparatuses and methods have not been shown in detail so as not to obscure the description of various embodiments. Additionally, as used herein, the term “or” may be construed in either an inclusive or exclusive sense.

The Abstract of the Disclosure is provided to allow the reader to quickly ascertain the nature of the technical disclosure. The abstract is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A filter to capture and retain particles from an air stream, the filter comprising:
a front face layer in which at least one impaction nozzle is formed to accelerate the air stream onto an interior substrate to capture large particle sizes with a calculated fractional efficiency, the interior substrate being formed within the filter;
a rear face layer in which at least one opening is formed to exhaust the air stream; and
a filter media material placed between the front face layer and rear face layer.

2. The filter of claim 1, wherein the filter is pleated to provide an increased surface area.

3. The filter of claim 1, wherein the front face layer is formed from one or more materials having properties that include being impermeable, semi-permeable, and permeable.

4. The filter of claim 1, wherein the at least one impaction nozzle is formed to have a geometrical shape including at least one of the shapes including round, rectangular, triangular, and a slot.

5. The filter of claim 1, wherein the filter media material is comprised of a high loft non-woven material.

6. The filter of claim 1, wherein the filter media material is tackified with a material selected from at least one of the materials including oil, adhesive, and liquids.

7. The filter of claim 1, wherein the filter media material includes at least one of embedded nano-particles and embedded nano-fibers.

8. The filter of claim 7, wherein the at least one of embedded nano-particles and embedded nano-fibers is tackified with oil, adhesive, or liquids.

9. The filter of claim 7, wherein the at least one of embedded nano-particles and embedded nano-fibers is charged electrostatically.

10. The filter of claim 1, wherein the filter media material is charged electrostatically.

11. The filter of claim 1, wherein the rear face layer is formed from one or more materials having properties that include being impermeable, semi-permeable, and permeable.

12. A multi-stage filter to capture and retain particles from an air stream, each stage of the multi-stage filter comprising:
a front face layer in which at least one impaction nozzle is formed to accelerate the air stream onto an interior substrate to capture large particle sizes with a calculated fractional efficiency, the interior substrate being formed within the filter;
a rear face layer in which at least one opening is formed to exhaust the air stream; and
a filter media material placed between the front face layer and rear face layer.

13. The multi-stage filter of claim 12, wherein each of the stages have the at least one impaction nozzle and the at least one opening staggered in relation to subsequent ones of the stages.

14. A diffusion filter to capture particles from and diffuse an incoming air stream, the diffusion filter comprising:
an front face layer having a plurality of impaction nozzles formed therein to accelerate and distribute the air stream onto a substrate;
a rear face layer having a plurality of openings formed therein to exhaust and further distribute the air stream; and
a filter media material formed between the front face layer and the rear face layer.

15. The diffusion filter of claim 14, wherein the diffusion filter is pleated to provide an increased surface area to capture particles and further to diffuse the air stream into a laminar flow.

16. The diffusion filter of claim 14, wherein the front face layer is formed from one or more materials having properties that include being impermeable, semi-permeable, and permeable.

17. The diffusion filter of claim 14, wherein the filter media material is charged electrostatically.

18. The diffusion filter of claim 14, wherein the filter media material is tackified with a material selected from at least one of the materials including oil, adhesive, and liquids.

19. The filter of claim 14, wherein the filter media material includes at least one of embedded nano-particles and embedded nano-fibers.

20. The filter of claim 19, wherein the at least one of embedded nano-particles and embedded nano-fibers is charged electrostatically.

21. The diffusion filter of claim 14, wherein the rear face layer is formed from one or more materials having properties that include being impermeable, semi-permeable, and permeable.

22. A process of successively capturing large particle sizes to small particle sizes from particle-laden air, the process comprising:
accelerating the particle-laden air through a plurality of impaction nozzles to accelerate and impact particles onto an impaction substrate;
passing the particle-laden air through a filter media material; and
exhausting remaining portions of the particle-laden air.
